(19) United States
(12) Patent Application Publication
(10) Pub. No.: US 2023/0263609 A1
(43) Pub. Date: Aug. 24, 2023

(54) PET DENTAL HYGIENE TOOL

(71) Applicant: KEVIN G. LYNCH, D.V.M., P.C., Center Moriches, NY (US)

(72) Inventor: Kevin G. LYNCH, Center Moriches, NY (US)

(21) Appl. No.: 17/652,394

(22) Filed: Feb. 24, 2022

(51) Int. Cl. A61D 5/00; A01K 13/00

(52) U.S. Cl. CPC A61D 5/00; A01K 13/001; A46B 2200/1086

(57) ABSTRACT

A pet dental hygiene tool includes an elongated handle having a first end and a second end, and at least one microfiber head fixed to at least one of the first end and the second end. The at least one microfiber head is configured to be inserted into a pet’s mouth and moved around the pet’s mouth in contact with at least one tooth or gum of the pet to absorb and remove particles therefrom.

### TECHNICAL FIELD

The present disclosure relates generally to pet hygiene tools, and more particularly to pet dental hygiene tools.

### BACKGROUND

Pet dental hygiene tools, such as toothbrushes, are typically constructed much like a toothbrush for a human, having a long straight handle and a brush head at the end of the handle. The brush is typically made of plastic or silicone bristles. To use, a user will insert the brush head into the pet’s mouth and use the handle to move the brush head in a “brushing motion” back and forth over the pet’s teeth and gums to mechanically scrub away food particles, bacteria and/or plaque that has accumulated on the pet’s teeth. Usually, such motion is uncomfortable for the pet. Dogs, for example, have more nerves in their gums than humans do, and therefore may experience significant discomfort during use of such brushes. Moreover, such brushes typically only move the food particles, bacteria and plaque around the mouth, but are not efficient at absorbing or removing the food particles, bacteria and plaque from the pet’s mouth altogether.

### SUMMARY

A pet dental hygiene tool includes an elongated handle having at least one head. For example, the pet dental hygiene tool may include two heads, one at each end of the handle. Instead of having a brush head, like a typical pet toothbrush, the at least one head of the pet dental hygiene tool described herein is made of a microfiber cloth material. Having superior absorption qualities compared to brush heads, the at least one microfiber head is configured to absorb and remove food particles, bacteria and plaque from a pet’s mouth. Also, the pet is more likely to find the microfiber head more comfortable and agreeable, as the user moves the microfiber head in a “massaging motion” over the pet’s teeth and gums.

According to an aspect of this disclosure, a pet dental hygiene tool includes an elongated handle having a first end and a second end, and at least one microfiber head fixed to at least one of the first end and the second end. The at least one microfiber head is configured to be inserted into a pet’s mouth and moved around the pet’s mouth in contact with at least one tooth or gum of the pet to absorb and remove particles therefrom.

According to an embodiment of any paragraph(s) of this summary, the at least one microfiber head is made of a microfiber material having a density in the range of 200 GSM to 900 GSM, 300 GSM to 800 GSM, 400 GSM to 700 GSM, or 500 GSM to 600 GSM.

According to another embodiment of any paragraph(s) of this summary, the elongated handle has an S-shape, extending in a longitudinal direction along a serpentine path.

According to another embodiment of any paragraph(s) of this summary, the at least one microfiber head includes a first microfiber head fixed to the first end of the handle and a second microfiber head fixed to the second end of the handle.

According to another embodiment of any paragraph(s) of this summary, the first microfiber head is made of a first microfiber material and the second microfiber head is made of a second microfiber material.

According to another embodiment of any paragraph(s) of this summary, the first microfiber material has a first density in the range of 400 GSM to 900 GSM, 500 GSM to 800 GSM, or 600 GSM to 700 GSM,

According to another embodiment of any paragraph(s) of this summary, the second microfiber material has a second density in the range of 100 GSM to 400 GSM, 200 GSM to 300 GSM, or 225 GSM to 175 GSM.

According to another embodiment of any paragraph(s) of this summary, the first microfiber head has a first color and the second microfiber head has a second color that is different than the first color.

According to another embodiment of any paragraph(s) of this summary, the elongated handle includes at least one finger rest.

According to another embodiment of any paragraph(s) of this summary, the elongated handle includes a first finger rest positioned adjacent the first microfiber head and a second finger rest positioned adjacent the second microfiber head.

According to another embodiment of any paragraph(s) of this summary, the first finger rest has a first color and the second finger rest has a second color that is different than the first color.

According to another embodiment of any paragraph(s) of this summary, the at least one microfiber head has a beveled disc shape having a first surface and a second surface opposite and parallel to the first surface.

According to another embodiment of any paragraph(s) of this summary, the beveled disc shape is a beveled oval disc shape.

According to another embodiment of any paragraph(s) of this summary, the at least one microfiber head is oriented relative to the elongated handle such that the first surface and the second surface face a vertical direction.

According to another embodiment of any paragraph(s) of this summary, the at least one microfiber head is oriented relative to the elongated handle such that the first surface and the second surface face a transverse direction.

According to another embodiment of any paragraph(s) of this summary, the at least one microfiber head is adjustable.

According to another embodiment of any paragraph(s) of this summary, the elongated handle includes at least one microfiber head anchoring substrate extending from at least one of the first end and the second end for supporting the at least one microfiber head.

According to another embodiment of any paragraph(s) of this summary, the elongated handle includes two longitudinal halves configured to press fit together.

According to another embodiment of any paragraph(s) of this summary, a first longitudinal half of the two longitudinal halves includes one or more aligning pins and a second longitudinal half of the two longitudinal halves includes one or more aligning pin receptacles configured to mate with the one or more aligning pins when press fit together.

According to another aspect of this disclosure, a method of cleaning teeth and gums of a pet using the pet dental hygiene tool of any paragraph(s) of this summary includes the step of inserting the at least one microfiber head of the pet dental hygiene tool into a mouth of the pet. The method then includes the step of moving, using the elongated handle of the pet dental hygiene tool, the at least one microfiber head around the mouth of the pet in contact with the teeth and gums of the pet to absorb and remove particles therefrom.

The following description and the annexed drawings set forth in detail certain illustrative embodiments described in this disclosure. These embodiments are indicative, however, of but a few of the various ways in which the principles of this disclosure may be employed. Other objects, advantages and novel features will become apparent from the following detailed description when considered in conjunction with the drawings.

### BRIEF DESCRIPTION OF DRAWINGS

The annexed drawings show various aspects of the disclosure.

FIG. 1 is a perspective view of a pet dental hygiene tool.

FIG. 2 is a side view of the pet dental hygiene tool of FIG. 1.

FIG. 3 is a perspective view of another embodiment of the pet dental hygiene tool.

FIG. 4 is a side view of the pet dental hygiene tool of FIG. 3.

FIG. 5A is an exploded view of the pet dental hygiene tool of FIGS. 1 and 2.

FIG. 5B is an exploded view of another pet dental hygiene tool.

FIG. 6 is a flowchart of a method of cleaning teeth and gums of a pet using the pet dental hygiene tool of any of FIGS. 1 to 5.

### DETAILED DESCRIPTION

With reference to the figures, a pet dental hygiene tool 10 includes an elongated handle 12 having a first end 12a and a second end 12b. The pet dental hygiene tool 10 also includes at least one microfiber head 14 fixed to at least one of the first end 12a and the second end 12b of the elongated handle 12. For example, as depicted, the at least one microfiber head 14 may include a first microfiber head 14a fixed to the first end 12a of the elongated handle 12, and a second microfiber head 14b fixed to the second end 12b of the elongated handle 12. The at least one microfiber head 14 is configured to be inserted into a pet’s mouth and moved around the pet’s mouth in contact with at least one tooth or gum of the pet to absorb and remove particles therefrom.

The pet for which the pet dental hygiene tool 10 is configured to be used may be, for example, a dog or a cat. It is understood, however, that the pet dental hygiene tool 10 described herein may be used with any pet having teeth or gums requiring the removal of particles therefrom for dental hygiene and dental health maintenance. For example, when food particles accumulate on a pet’s teeth and gums, bacteria can interact with the food particles and create plaque. This plaque can build up on the pet’s teeth and gums and cause periodontal disease if not prevented or removed. Therefore, the particles that the pet dental hygiene tool 10 described herein is configured to remove may include, for example, food particles, bacteria, and plaque. It is understood, however, that the pet dental hygiene tool 10 described herein may be configured to remove other particles located within the pet’s mouth or accumulated on the teeth or gums of the pet. By effectively absorbing and removing such particles from the teeth and gums of the pet, use of the pet dental hygiene tool 10 described herein serves as a preventative measure to avoid accumulation of particles that may lead to periodontal disease in the pet.

The elongated handle 12 may have an S-shape, extending in a longitudinal direction 16 (x-axis) along a serpentine path. This allows for an ergonomic grip on the elongated handle 12 by the user of the pet dental hygiene tool 10. Additionally, the S-shape of the elongated handle 12 enhances a contact pressure of the at least one microfiber head 14 against the teeth and gums of the pet while the user moves the at least one microfiber head 14 in contact with the pet’s teeth and gums. The elongated handle 12 may have a length in the longitudinal direction 16 in the range of 12.70 centimeters (5 inches) to 30.48 centimeters (12 inches), 15.24 centimeters (6 inches) to 27.94 centimeters (11 inches), 17.78 centimeters (7 inches) to 25.40 centimeters (10 inches), or 20.32 centimeters (8 inches) to 22.86 centimeters (9 inches). The elongated handle 12 may have a height in a vertical direction 19 (y-axis) in the range of 0.51 centimeters (0.20 inch) to 1.78 centimeters (0.70 inch) or 0.64 centimeters (0.25 inch) to 1.65 centimeters (0.65 inch). The height of the elongated handle 12, however, may not be uniform across the entirety of the length in the longitudinal direction 16. For example, as depicted in the figures, the height may be greater in the center of the elongated handle 12 in the longitudinal direction 16 relative to the first end 12a and second end 12b of the elongated handle 12. As a non-limiting example, the first end 12a and the second end 12b of the elongated handle 12 may have a height in a vertical direction (y-axis) of 0.64 centimeters (0.25 inch) and a center of the elongated handle 12 between the first end 12a and the second end 12b may have a height in a vertical direction (y-axis) of 1.65 centimeters (0.65 inch).

The elongated handle 12 may have a width in a transverse direction 21 (z-axis) in the range of 0.51 centimeters (0.20 inch) to 2.54 centimeters (1 inch), 0.76 centimeters (0.3 inch) to 2.29 centimeters (0.9 inch), or 0.84 centimeters (0.33 inch) to 2.16 centimeters (0.85 inch). The width of the elongated handle 12, however, also may not be uniform across the entirety of the length in the longitudinal direction 16. For example, as depicted in the figures, the width may be greater in the center of the elongated handle 12 in the longitudinal direction 16 relative to the first end 12a and the second end 12b of the elongated handle 12. As a non-limiting example, the first end 12a and the second end 12b of the elongated handle 12 may have a width in the transverse direction (z-axis) of 0.84 centimeters (0.33 inch) and a center of the elongated handle 12 between the first end 12a and the second end 12b may have a width in the transverse direction (z-axis) of 2.16 centimeters (0.85 inch). The elongated handle 12 may be made of, for example, a polymer such as any one of acrylonitrile butadiene styrene, polypropylene, or a combination thereof. It is understood that the above example materials are provided as non-limiting examples, and that other suitable materials may be used for the elongated handle 12.

Additionally, to promote the ergonomic grip on the elongated handle 12 by the user and the enhanced contact pressure described above, the elongated handle 12 may include at least one finger rest 18. To use the pet dental hygiene tool 10 to clean teeth and gums of the pet, therefore, a user may grasp the elongated handle 12 and rest their finger or thumb on the at least one finger rest 18. The user may then insert the at least one microfiber head 14 into the pet’s mouth and move the at least one microfiber head 14 around the pet’s mouth in contact with the pet’s teeth and gums in a circular “massaging motion” or other similar motion.

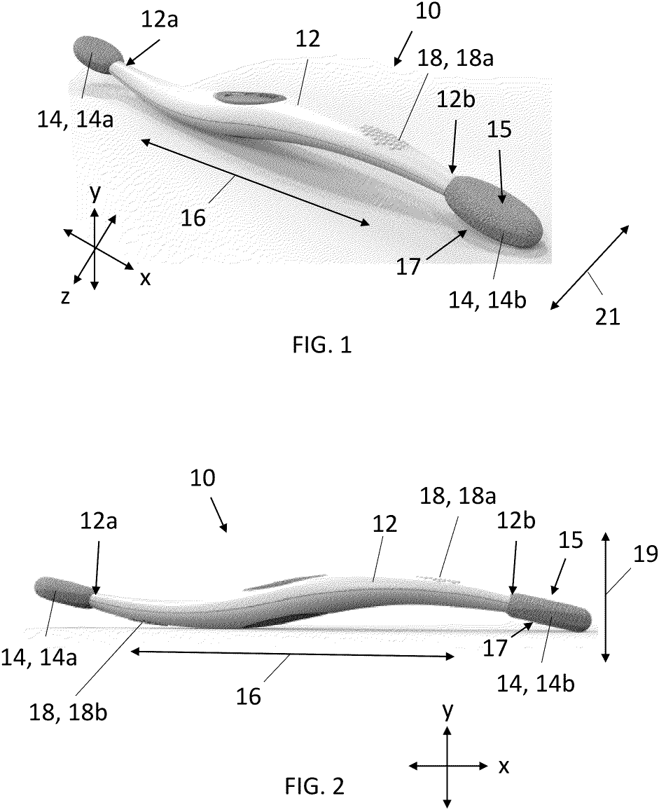

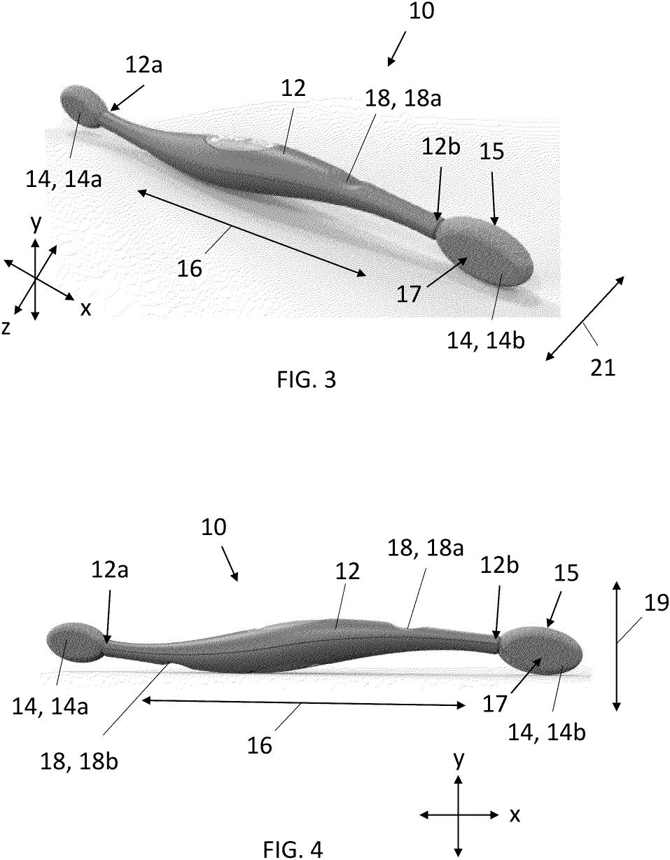

In the depicted embodiment in which the at least one microfiber head 14 includes the first microfiber head 14a and the second microfiber head 14b, the elongated handle may include a first finger rest 18a adjacent the first microfiber head 14a and a second finger rest 18b adjacent the second microfiber head 14b. The first finger rest 18a and the second finger rest 18b may be disposed on opposite sides of the elongated handle 12 in both the longitudinal direction 16 (x-axis) and in the vertical direction 19 (y-axis). In this manner, at least one of the user’s finger or thumb may rest on either the first finger rest 18a or the second finger rest 18b when the user is using is using the first microfiber head 14a or the second microfiber head 14b, respectively. The at least one finger rest 18 may be a smooth or textured protrusion on the elongated handle 12. For example, as depicted in FIGS. 1 and 2, the at least one finger rest 18 may be a clustered plurality of protrusions extending from a surface of the elongated handle 12. In an alternative embodiment depicted in FIGS. 3 and 4, the at least one finger rest 18 may be a smooth or textured depression on the surface of the elongated handle 12. In either embodiment, the at least one finger rest 18 may be quickly and easily identifiable by the user so that the user can rest their finger or thumb thereon during use of the pet dental hygiene tool 10.

The at least one microfiber head 14 may have a beveled disc shape having a first surface 15 and a second surface 17 opposite and parallel to the first surface 15. The beveled disc shape may be a beveled oval disc shape. At least one surface 15, 17 of the at least one microfiber head 14 is configured to contact the teeth and gums of the pet such that a significant portion of the total surface area of the at least one microfiber head 14 (the surface area of the at least one surface 15, 17) can effectively absorb and remove particles from the teeth and gums of the pet. It will be understood that the beveled disc shape of the at least one microfiber head 14 is provided as a non-limiting example, and that the at least one microfiber head 14 may have another shape, such as, for example, a beveled or non-beveled circle, square, rectangle, or other suitable shape having a first surface and a second surface.

The at least one microfiber head 14 may be oriented such that the first surface 15 and the second surface 17 of the at least one microfiber head 14 face any direction relative to the handle. For example, in the embodiment of FIGS. 1 and 2, the first surface 15 and the second surface 17 of the at least one microfiber head 14 face in the vertical direction (y-axis). In the alternative embodiment of FIGS. 3 and 4, however, the first surface 15 and the second surface 17 of the at least one microfiber head 14 face in the transverse direction 21 (z-axis). The orientation of the at least one microfiber head 14 depicted in these embodiments are non-limiting examples and it is understood that the at least one microfiber head 14 may be alternatively oriented such that the first surface 15 and the second surface 17 may face any other direction. For example, the at least one microfiber head 14 may be adjustable relative to the handle 12 such that the orientation of the at least one microfiber head 14 may be adjustable and the first surface 15 and the second surface 17 may face any direction. In this manner, the user may adjust the direction in which the first surface 15 and the second surface 17 face to ensure optimal contact of at least one of the first surface 15 and the second surface 17 with the teeth and gums of the pet during use of the pet dental hygiene tool 10.

The at least one microfiber head 14 may be made with a split microfiber material having fibers that are less than 10 micrometers (1 denier) in diameter. Specifically, the material of the at least one microfiber head 14 may have fibers having a diameter in the range of 1 micrometer to 10 micrometers, 2 micrometers to 9 micrometers, 3 micrometers to 8 micrometers, 4 micrometers to 7 micrometers, or 5 micrometers to 6 micrometers. The material of the at least one microfiber head 14 may have a net positive charge that serves as an adhesive force, making the material able to easily attract negatively charged particles. Specifically, split microfiber is known to be much more absorbent than other types of material and to be able to remove large quantities of microbes, including spores. The material may be made of nylon, polyester, polyamide, or any blend thereof. For example, the material may have a blend ratio of polyester to polyamide in the range of 70/30 to 80/20. The material may have a density, measured in grams per square inch (GSM) in the range of 200 GSM to 900 GSM, 300 GSM to 800 GSM, 400 GSM to 700 GSM, or 500 GSM to 600 GSM.

In an embodiment in which the at least one microfiber head 14 includes the first microfiber head 14a and the second microfiber head 14b, the first microfiber head 14a may be made of a first microfiber material having a first density and the second microfiber head 14b may be made of a second microfiber material having a second density, the second density being higher than the first density. For example, the first microfiber material of the first microfiber head 14a may have the first density in the range of 100 GSM to 400 GSM, 200 GSM to 300 GSM, or 225 GSM to 175 GSM. The first microfiber material may therefore be used for general absorption of particles from the pet’s teeth and gums. The second microfiber material of the second microfiber head 14b may have the second density in the range of 400 GSM to 900 GSM, 500 GSM to 800 GSM, or 600 GSM to 700 GSM. The second microfiber material may therefore be used not only for absorption of particles from the pet’s teeth and gums, but also for polishing the pet’s teeth and gums. The specific types of microfiber materials, fiber diameters, and densities of microfiber materials described herein are provided as non-limiting examples and it will be understood that other suitable types, fiber diameters, and densities of microfiber materials may be applied to the pet dental hygiene tool 10 described herein. Additionally, the first microfiber head 14a and the second microfiber head 14b may have various patterns woven into the first and second microfiber material, such as, for example, a checkered pattern, a striped pattern, or any other pattern.

To distinguish the first microfiber head 14a from the second microfiber head 14b, the first microfiber head 14a may have a first color and the second microfiber head 14b may have a second color that is different than the first color. Additionally or alternatively, the first microfiber head 14a may have a first woven pattern and the second microfiber head 14b may have a second woven pattern. In this manner, the user can more quickly and easily distinguish the first microfiber head 14a having the first microfiber material with the first density from the second microfiber head 14b having the second microfiber material with the second density. Additionally, the first finger rest 18a may have the first color to match the first microfiber head 14a and the second finger rest 18b may have the second color to match the second microfiber head 14b.

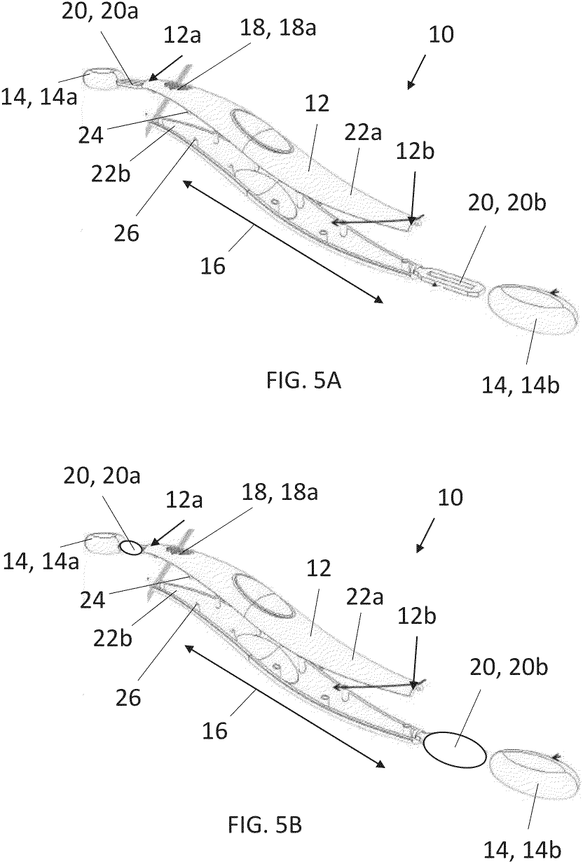

With reference to FIGS. 5A and 5B, the pet dental hygiene tool 10 is depicted in an exploded view. As depicted, the elongated handle 12 may include at least one microfiber head anchoring substrate 20 extending from at least one of the first end 12a and the second end 12b of the elongated handle 12 for supporting the at least one microfiber head 14. For example, as depicted, the at least one microfiber head anchoring substrate 20 includes a first microfiber head anchoring substrate 20a extending from the first end 12a of the elongated handle 12, and a second microfiber head anchoring substrate 20b extending from the second end 12b of the elongated handle 12. At least one of the first microfiber head anchoring substrate 20a and the second microfiber head anchoring substrate 20b may be shaped as an elongated oval or rectangle and may have dimensions smaller than each of the respective at least one microfiber head 14, so as to fit inside and be overlaid by the at least one microfiber head 14. The elongated shape of the first microfiber head anchoring substrate 20a and the second microfiber head anchoring substrate 20b may have a hole therein, to save on material, as depicted in FIG. 5A. Alternatively, the elongated shape of the first microfiber head anchoring substrate 20a and the second microfiber head anchoring substrate 20b may have a “pedal-type” design and may be flat and solid, as depicted in FIG. 5B. The first microfiber head 14a and the second microfiber head 14b may be fixed to the first microfiber head anchoring substrate 20a and the second microfiber head anchoring substrate 20b, respectively, with for example an adhesive.

Additionally, the elongated handle 12 may include two longitudinal halves 22a, 22b configured to press fit together. For example, a first longitudinal half 22a may include one or more aligning pins 24 and the second longitudinal half 22b may include one or more corresponding aligning pin receptacles 26 configured to mate with the one or more aligning pins 24 when press fit together. The aligning pins 24 and aligning pin receptacles 26 hold the first longitudinal half 22a and the second longitudinal half 22b together via an interference fit between the aligning pins 24 and the aligning pin receptacles 26. Alternatively, the first longitudinal half 22a and the second longitudinal half 22b may be otherwise fixed together, such as with an adhesive such as a solvent or glue bonding, or ultrasonic welding. It is understood, however, that the above ways of fixing the first longitudinal half 22a and the second longitudinal half 22b are provided as non-limiting examples, and that other methods of fixing the first longitudinal half 22a and the second longitudinal half 22b may be applicable to the elongated handle 12.

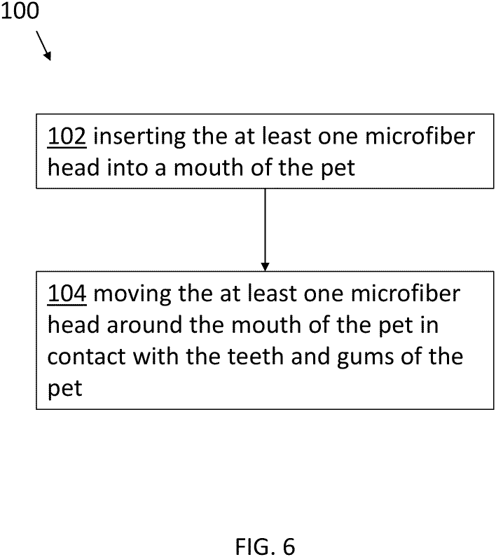

With reference to FIG. 6, a method 100 of cleaning teeth and gums of a pet is depicted in a flowchart. The method 100 uses the pet dental hygiene tool 10 described above. Specifically, the method 100 includes the step 102 of inserting the at least one microfiber head 14 of the pet dental hygiene tool 10 into a mouth of the pet. The step 102 of inserting the at least one microfiber head 14 may include grasping the elongated handle 12 and resting a finger or thumb of the user on the at least one finger rest 18. The method 100 then includes the step 104 of moving, using the elongated handle 12, the at least one microfiber head 14 around the mouth of the pet in contact with the teeth and gums of the pet to absorb and remove particles therefrom. The step 104 of moving may include moving the at least one microfiber head 14 in a “massaging motion”, such as in a gentle circular motion. The method 100, using the pet dental hygiene tool 10 described herein, is more effective at absorbing and removing particles from the pet’s teeth and gums than other methods using traditional pet toothbrushes. Moreover, the method 100 described herein is more comfortable and tolerable to pets than other methods using traditional pet toothbrushes, as pets tend to experience significant discomfort with the use of traditional pet toothbrushes. In this way, the method 100 of cleaning the teeth and gums of a pet may efficiently and easily provide a preventative measure to avoid accumulation of particles that may lead to periodontal disease in the pet.

Although the above disclosure has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature may have been described above with respect to only one or more of several illustrated embodiments, such feature may be combined with one or more other features of the other embodiments, as may be desired and advantageous for any given or particular application.

What is claimed is:

1. A pet dental hygiene tool, comprising:
an elongated handle having a first end and a second end; and
at least one microfiber head fixed to at least one of the first end and the second end, the at least one microfiber head being configured to be inserted into a pet’s mouth and moved around the pet’s mouth in contact with at least one tooth or gum of the pet to absorb and remove particles therefrom.

2. The pet dental hygiene tool according to claim 1, wherein the at least one microfiber head is made of a microfiber material having a density in the range of 200 GSM to 900 GSM, 300 GSM to 800 GSM, 400 GSM to 700 GSM, or 500 GSM to 600 GSM.

3. The pet dental hygiene tool according to 1, wherein the elongated handle has an S-shape, extending in a longitudinal direction along a serpentine path.

4. The pet dental hygiene tool according to claim 1, wherein the at least one microfiber head includes a first microfiber head fixed to the first end of the handle and a second microfiber head fixed to the second end of the handle.

5. The pet dental hygiene tool according to claim 4, wherein the first microfiber head is made of a first microfiber material and the second microfiber head is made of a second microfiber material.

6. The pet dental hygiene tool according to claim 5, wherein the first microfiber material has a first density in the range of 400 GSM to 900 GSM, 500 GSM to 800 GSM, or 600 GSM to 700 GSM.

7. The pet dental hygiene tool according to claim 5, wherein the second microfiber material has a second density in the range of 100 GSM to 400 GSM, 200 GSM to 300 GSM, or 225 GSM to 175 GSM.

8. The pet dental hygiene tool according to claim 4, wherein the first microfiber head has a first color and the second microfiber head has a second color that is different than the first color.

9. The pet dental hygiene tool according to claim 1, wherein the elongated handle includes at least one finger rest.

10. The pet dental hygiene tool according to claim 9, wherein the elongated handle includes a first finger rest positioned adjacent the first microfiber head and a second finger rest positioned adjacent the second microfiber head.

11. The pet dental hygiene tool according to claim 10, wherein the first finger rest has a first color and the second finger rest has a second color that is different than the first color.

12. The pet dental hygiene tool according to claim 1, wherein the at least one microfiber head has a beveled disc shape having a first surface and a second surface opposite and parallel to the first surface.

13. The pet dental hygiene tool according to claim 12, wherein the beveled disc shape is a beveled oval disc shape.

14. The pet dental hygiene tool according to claim 12, wherein the at least one microfiber head is oriented relative to the elongated handle such that the first surface and the second surface face a vertical direction.

15. The pet dental hygiene tool according to claim 12, wherein the at least one microfiber head is oriented relative to the elongated handle such that the first surface and the second surface face a transverse direction.

16. The pet dental hygiene tool according to claim 1, wherein the at least one microfiber head is adjustable.

17. The pet dental hygiene tool according to claim 1, wherein the elongated handle includes at least one microfiber head anchoring substrate extending from at least one of the first end and the second end for supporting the at least one microfiber head.

18. The pet dental hygiene tool according to claim 1, wherein the elongated handle includes two longitudinal halves configured to press fit together.

19. The pet dental hygiene tool according to claim 18, wherein a first longitudinal half of the two longitudinal halves includes one or more aligning pins and a second longitudinal half of the two longitudinal halves includes one or more aligning pin receptacles configured to mate with the one or more aligning pins when press fit together.

20. A method of cleaning teeth and gums of a pet using the pet dental hygiene tool according to claim 1, the method comprising the steps of:
inserting the at least one microfiber head of the pet dental hygiene tool into a mouth of the pet; and
moving, using the elongated handle of the pet dental hygiene tool, the at least one microfiber head around the mouth of the pet in contact with the teeth and gums of the pet to absorb and remove particles therefrom.
